(19) United States
(12) Patent Application Publication
(10) Pub. No.: US 2003/0019174 A1
(43) Pub. Date: Jan. 30, 2003

(54) Method for installing wood flooring

(76) Inventor: Manuel Bolduc, St-Denis-de-Brompton (CA)

Correspondence Address: Eric Fincham, 316 Knowlton Road, Lac Brome, QC, J0E 1V0, CA

(21) Appl. No.: 09/915,069

(22) Filed: Jul. 25, 2001

(51) Int. Cl. B32B 3/00

(52) U.S. Cl. 52/290; 52/392; 52/539

(57) ABSTRACT

There is provided a flooring system for hardwood floors comprised of a plurality of elongated slats wherein the slats are held in position by a plurality of connectors, each connector having a base secured to a substrate, a vertical portion extending upwardly from the base, and a generally horizontal portion extending into a groove formed in a side wall of the elongated slat. The system permits the slats to be installed with a minimum of labor and also permits removal of the slats and their later re-use.

### FIELD OF THE INVENTION

The present invention relates to a connector and more particularly, relates to a connector for use in a flooring system.

### BACKGROUND OF THE INVENTION

There are many different types of flooring which are used both in residential and commercial applications. Flooring systems range from hardwood floors to various composite wood products, tiles, linoleum, slate, carpets, etc. Each of the aforementioned types of flooring has various advantages and disadvantages, with some of the parameters for suitability for any particular installation being cost of the flooring material, cost of installation, durability, appearance, ease of maintenance, etc.

For a residential and many commercial installations, the use of wood and notably a hardwood is considered desirable particularly from an aesthetic viewpoint. Historically, some of the drawbacks associated with hardwood flooring have been the cost of installation and maintenance. Typically, hardwood flooring comes in slats of solid wood which must be secured to a substrate. In most instances, the wood slats have a tongue and groove arrangement formed on their side walls and the slats are secured by toenailing a nail through the tongue portion. Although there are a number of automatic nailing guns which are suitable for performing this operation, thus speeding up the installation, it is still a time consuming operation. Still further, many of the woods used in the flooring have a tendency to split when the nail is driven. In order to prevent this splitting, it then becomes necessary to pre-drill a pilot hole for the nail. This is again very time consuming and thus increases the expense of installation.

Still further, wood floors, in high traffic areas, are subject to a wear factor. After a certain period of time, it becomes necessary to refinish the floors which typically comprises an operation to remove the old surface coating by means of a sander and subsequently refinishing the floors. This operation is one which requires some skill on the part of the operator of the sander in order to maintain a level and smooth surface. It is also an extremely messy and possibly health threatening operation as fine particles of dust spread throughout the area. Before applying the coating to the wood, all dust particles must be removed; this is often a tedious process.

### SUMMARY OF THE INVENTION

It is an object of the present invention to provide a flooring system for installing a plurality of elongated slats, the system being one wherein installation is substantially faster than the use of nails.

It is a further object of the present invention to provide a system for the installation of wood slats having a tongue and groove configuration.

It is a further object of the present invention to provide a connector suitable for use in installing elongated slats having a tongue and groove arrangement.

It is a still further object of the present invention to provide a method for installing elongated hardwood slats to form a floor.

According to one aspect of the present invention, there is provided a floor comprising a plurality of elongated slats, each slat having a top wall, a bottom wall, and first and second opposed side walls, the slats being laid in a side by side relationship with a first side wall of a first slat abutting a second side wall of a second slat, a groove formed in each of the first side walls, a side wall recessed portion formed in one of the first and second side walls below the groove, a bottom recess formed in each of the bottom walls of each of the slats adjacent the second side wall, a plurality of connectors, each connector comprising a base secured to a substrate, a vertical portion extending upwardly from the base and fitting within the side wall recessed portion, and a generally horizontal portion extending into the groove formed in the first side wall to thereby secure the slat in position.

According to a further aspect of the present invention, there is provided a method of installing a wood floor comprising a plurality of elongated slats, each slat having a top wall, a bottom wall and first and second opposed side walls, a groove formed in each of the first side walls of each of the slats, a side wall recessed portion formed in one of the first and second side walls of each of the slats below the groove, a bottom recess formed in each of the bottom walls of each of the slats adjacent a respective second side wall, a method comprising the steps of supplying a plurality of connectors, a vertical portion extending upwardly from the base and a generally horizontal portion, a method comprising the steps of securing a connector to a substrate, placing a slat on the substrate with the horizontal portion extending into the groove formed in the first side wall to thereby secure the slat in position, and continuing to place subsequent slats in a side by side abutting relationship with a connector holding each slat in position.

The connector used in the present invention has a first portion thereof which is adapted to be secured to the substrate. Typically, the substrate is of a wood material such as a plywood or composite wood material. Typically, the connector may be secured to the substrate by mechanical means such as nails or screws. Screws are a preferred securing mechanism for reasons which will become apparent hereinbelow. However, it will be understood that other securement means such as adhesive or the like may be utilized particularly in the instance wherein the substrate is not a material easily penetrable by screws.

The connector will include a upwardly extending vertical portion having at its upper end thereof at least one horizontally extending tab portion. The horizontally extending tab portion is designed to engage a slot or recess formed in a side wall of a slat. In one embodiment, the horizontally extending tab portion may engage the groove in a conventional tongue and groove type of flooring.

In a preferred embodiment, the upwardly extending vertical portion has at least a pair of horizontally extending tab portions, at least one tab portion extending outwardly in each horizontal direction such that a single connector will engage both of a pair of abutting slats.

The connector is designed to be used, as aforementioned, in a flooring system comprising a plurality of slats engaged in an abutting side by side relationship. To this end, the slats are formed with recessed portions to receive both the base portion of the connector and the vertical portion thereof.

The connector may be formed of any suitable material and thus is preferably either of a metal or plastic material. A formed metal material would be suitable while an extruded plastic material could also be utilized.

In the preferred embodiment, the connector is formed of a metallic material and may easily be formed by a suitable mechanical means to have the desired configuration. In this configuration, the connector has a base which has means for securement to the substrate. Typically, such means may include apertures formed within the base which lies co-planer with the substrate and may be secured thereto by a mechanical means such as a screw or the like.

The connector also includes a vertical portion which extends upwardly adjacent to at least a portion of a side wall of abutting slats. To provide space for the upwardly extending wall, one of the side walls of the slats has a recess formed therein.

One or both of the side walls of each of the slats has a longitudinally extending groove formed therein. A corresponding tab extends outwardly from the upwardly extending wall of the connector and is designed to engage within the longitudinally extending slot and thereby retain the slat in position.

The bottom end side recesses are formed of a size sufficient to accommodate the connector. Typically, the bottom recess would have a width of between 6 mm and 50 mm and a depth of between 3 mm and 12 mm. Similarly, the side wall recessed portion would be sized to receive the vertical portion of the connector and accordingly would generally have a depth of between 3 mm and 12 mm.

In an alternative embodiment, the connector of the present invention may be arranged to be used in conjunction with a conventional tongue and groove flooring with the tab portion being arranged to engage the groove formed within the slat. Again, proper sizing of the tongue to permit the same would be provided.

As above described, the wood slats may have different configurations. In a particularly preferred embodiment, the side walls of the slats may also be formed such that one side wall will have a upper recessed portion designed to receive a projecting portion of an adjacent slat.

### BRIEF DESCRIPTION OF THE DRAWINGS

Having thus generally described the invention, reference will be made to the accompanying drawings illustrating an embodiment thereof, in which:

FIG. 1 is a perspective view of a connector according to one embodiment of the present invention, with the connector being shown in place with a slat in broken lines;

FIG. 2 is an end view of the connector;

FIG. 3 is a side elevational view thereof;

FIG. 4 is a top plan view thereof;

FIG. 5 is a side sectional view illustrating placement of the connector in conjunction with a pair of slats;

FIG. 6 is a side view, partially in section, of a conventional tongue and groove flooring system utilizing a connector according to the present invention; and

FIG. 7 is a view similar to FIG. 5 showing a modified form of a slat which may be used in the present invention.

### DESCRIPTION OF THE PREFERRED EMBODIMENTS

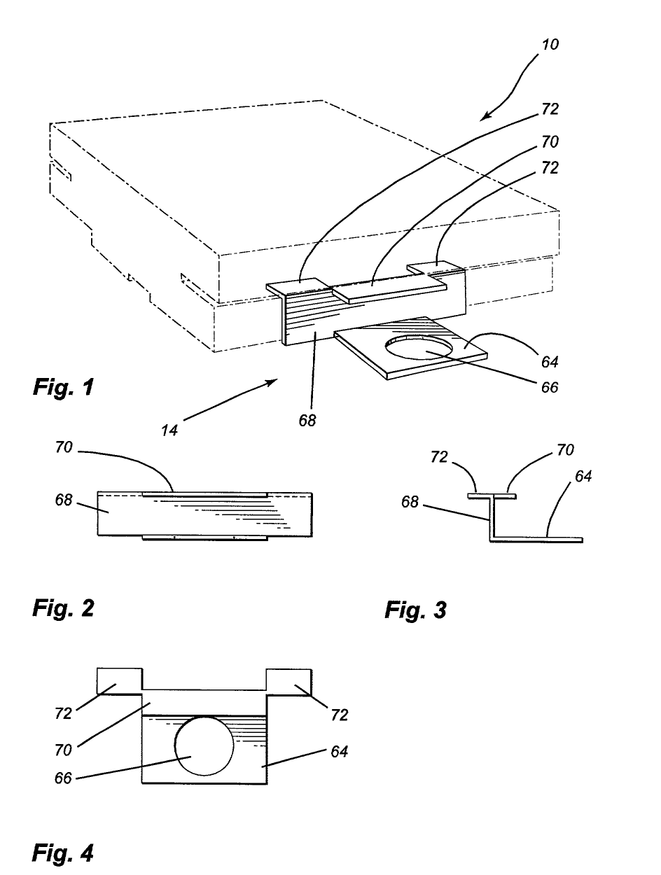

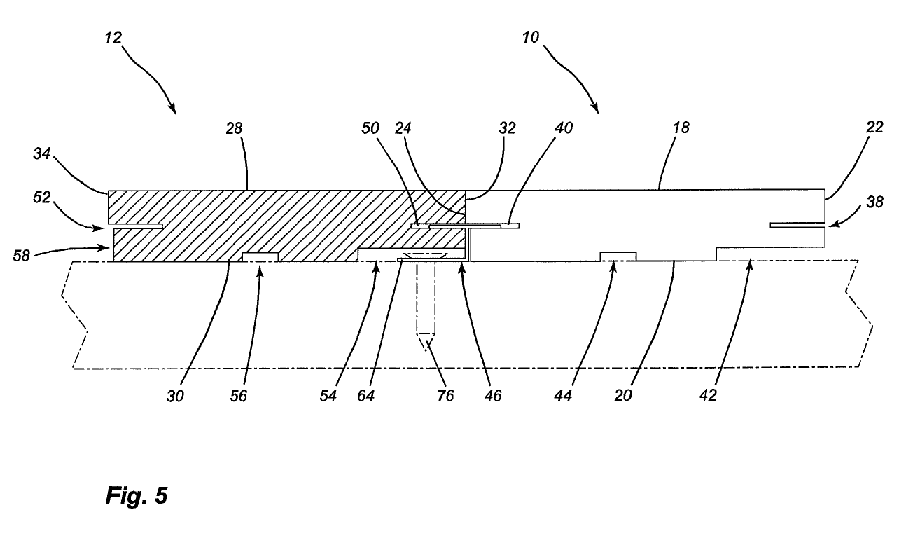

Referring to the drawings in greater detail and by reference characters thereto, and referring initially to FIG. 5, there are illustrated a first slat 10 and a second slat 12 lying in an abutting relationship. A connector generally designated by reference numeral 14 (FIG. 1) is used to secure slats 10 and 12 in position.

First slat 10 has an upper wall 18, a bottom wall 20, a first side wall 22, and a second side wall 24.

Second slat 12 is placed in an abutting relationship to first slat 10. Second slat 12 includes an upper wall 28 which will be co-planer with upper wall 18 of first slat 10; a first side wall 32 which lies in an abutting relationship with second side wall 24 of first slat 10; a bottom wall 30 which is also substantially co-planer with bottom wall 20 of first slat 10; and a second side wall 34.

As may be seen in FIG. 5, slat 10 has a long first side wall 22 in which there is a longitudinally extending slot which is generally designated by reference numeral 38. Similarly, along second side wall 24, there is provided an inwardly directed longitudinally extending slot 40.

There is also provided a bottom wall recess generally designated by reference numeral 42 and which is provided within bottom wall 20 and extends to first side wall 22. A conventional groove 44 within bottom wall 20 is provided intermediate first side wall 22 and second side wall 24 in a conventional fashion to provide dimensional stability to slat 10.

A side wall recess 46 is provided within second side wall 24 and is located at the point of juncture of second side wall 24 and bottom wall 20.

Slat 12 has a similar configuration to slat 10—i.e. slat 12 includes a first longitudinally extending slot 50 within first side wall 32 and a second longitudinally extending slot 52 within second side wall 34. A bottom wall recess 54 is provided adjacent first side wall 32 while a side wall recess 58 is provided in second side wall 34. A centrally located longitudinally extending groove 56 is also formed in bottom wall 30.

As may be best seen in FIGS. 1 to 4, connector 14 has a base portion 64 which is adapted to lie flat on a substrate to which it is to be secured. To this end, an aperture 66 is provided within base portion 64.

Extending upwardly from base portion 64 is a vertical wall 68. At the distal end of vertical wall 68, there is provided a first tab member 70 which is substantially perpendicular with respect to vertical wall 68. A pair of tabs 72 are formed on either side of first tab 70, tabs 72 lie in the same horizontal plane as tab 70 but extend in an opposite direction.

In use, and as may be seen in FIG. 5, a connector is secured by means of a screw 76 to a substrate through aperture 66 of base 64. Vertical wall 68 fits within side wall recess 46 of slat 10. Tab 70 then is designed and sized to fit within longitudinally extending slot 40 while tabs 72 fit within slot 50 formed in side wall 32 of slat 12. Connector 14 thus functions to stabilize and maintain slats 10 and 12 in position.

When installing a floor comprised of a plurality of longitudinally extending slats such as 10 and 12, a first slat 10 may be placed in position along a wall. In this respect, first side wall 22 of slat 10 could abut the wall and then a connector 14 secured as shown in FIG. 5. A second slat 12 would then be placed in position and the process repeated.

Alternatively, a first row of connectors 14 may be provided for initial slat 10. The first row of connectors may utilize tab 72 as a spacer from an adjacent wall or alternatively, a special connector not having a tab 72 may be utilized.

Utilizing the above system, the only connection required is the attachment of connector 14 to the substrate by means of a member such as screw 76. This could be accomplished rapidly using automated equipment for driving screws 76.

The connectors 14 may be spaced apart by a suitable distance. Generally, the spacers may be provided at a distance of between 10 to 15 centimeters. Naturally, it will be understood that a continuous connector strip could be utilized. It will also be understood that the slats may comprise individual slats connected in an end to end arrangement with a connector being used where the ends abut each other.

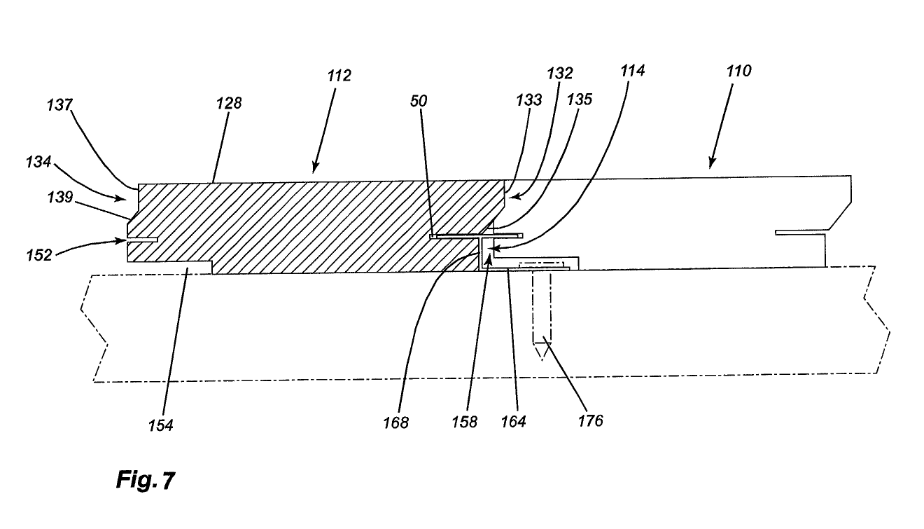

In FIG. 7, a slightly modified version of the system shown in FIGS. 1 to 5 is illustrated. In this embodiment, there is provided a pair of slats 110 and 112 lying in a side by side abutting relationship. A connector generally designated by reference numeral 114 is employed between slats 110, 112 and is secured to the substrate by means of screw 176. Connector 114 is identical to that previously described.

In the embodiment of FIG. 7, slat 112 has a first side wall generally designated by reference numeral 132 and which includes an upper vertical portion 133 and a lower tapered portion 135. A recess generally designated by reference numeral 158 and which is similar to recess 58 of the previous embodiment is formed in side wall 132.

Side wall 134 includes a vertical section 137 and an outwardly tapered wall section 139. A bottom recess 154 is provided to receive base 164 of connector 114. In this arrangement, a thinner slat may be utilized.

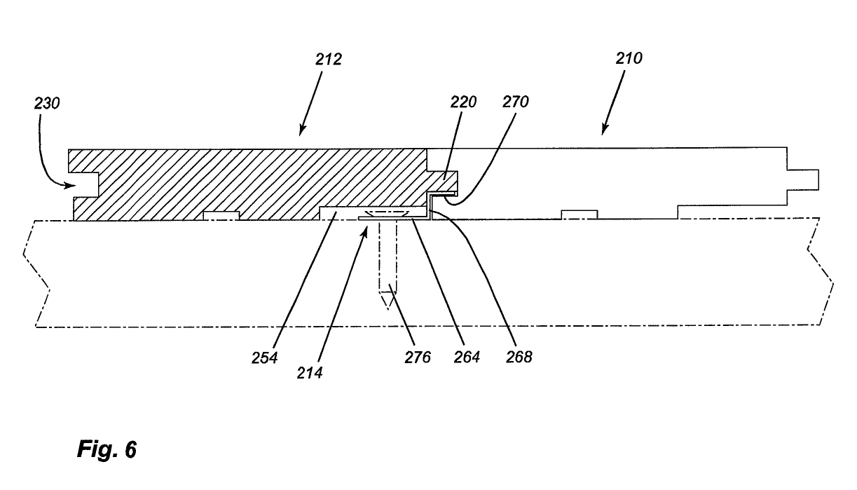

Turning to FIG. 6, there are illustrated two slats 210 and 212. Referring to slat 212, this is formed in a substantially conventional manner in that there is provided a tongue 220 and a groove 230 on the opposite side wall. In this arrangement, a connector generally designated by reference 214 has a base portion 264 with apertures therein to permit the passage of screws 276. A vertical portion 268 is also provided as well as a tab 270.

In this arrangement, groove 230 is formed to have a sufficient height to accommodate both tongue 220 and the thickness of tab 270. The side wall having groove 230 has the bottom portion thereof forming a recess to accommodate vertical portion 268 while a bottom recess 254 is provided to accommodate base 264 and the head of screw 276.

An advantage of using the above system is that the floor may be securely attached in a manner which permits removal of the same. Thus, in a typical residential application, the sub-flooring or substrate would be plywood or similar material. When it is desired to refinish the floor, it can be rapidly lifted and the individual slats forwarded to a commercial facility for refinishing. The floor, after refinishing, could then be reinstalled. For the average consumer, this would both be less time consuming and less expensive than performing the refinishing on site. The use of this system will also permit one to replace a floor and use the removed floor in another location.

It will be understood that the above described embodiments are for purposes of illustration only and that changes or modifications may be made thereto without departing from the spirit and scope of the invention.

I claim:

1. A flooring system for installing wood boards, each board comprising an elongated slat having a top wall, a bottom wall, and first and second opposed side walls;
a groove formed in said first side wall, a side wall recessed portion formed in said first side wall below said groove;
a bottom recess formed in said bottom wall adjacent said second side wall;
a connector comprising a base, said base having means for securement to said substrate, a vertical portion extending upwardly from said base, and a generally horizontal portion extending outwardly from said generally vertical portion.

2. The flooring system of claim 1 wherein said connector has a first and second generally horizontal portions, said first and second generally horizontal portions extending in opposite directions from said generally vertical portion, and said board has a second groove formed in said second side wall.

3. The flooring system of claim 1 wherein said base of said connector has an aperture therein to receive a screw.

4. A floor comprising a plurality of elongated slats, each slat having a top wall, a bottom wall, and first and second opposed side walls, said slats being laid in a side by side relationship with a first side wall of a first slat abutting a second side wall of a second slat;
a groove formed in each of said first side walls, a side wall recessed portion formed in one of said first and second side walls below said groove;
a bottom recess formed in each of said bottom walls of each of said slats adjacent said second side wall;
a plurality of connectors, each connector comprising a base secured to a substrate, a vertical portion extending upwardly from said base and fitting within said side wall recessed portion, and a generally horizontal portion extending into said groove formed in said first side wall to thereby secure said slat in position.

5. The system of claim 4 wherein said connector has first and second generally horizontal portions, said first and second generally horizontal portions extending in opposite directions from said generally vertical portion, said slat having a second groove formed in said second side wall.

6. The system of claim 4 wherein said base has an aperture therein to receive a screw to thereby secure said base to said substrate.

7. The system of claim 4 wherein said bottom recess comprises a continuous bottom recess formed in said bottom side wall adjacent said second side wall.

8. The system of claim 7 wherein said bottom recess has a width of between 6 mm and 50 mm and a depth of between 3 mm and 12 mm.

9. The system of claim 4 wherein said side wall recessed portion extends inwardly a distance of between 3 mm and 12 mm.

10. The system of claim 4 wherein said connectors are spaced apart a distance of between 10 cm to 15 cm.

11. A method of installing a wood floor comprising a plurality of elongated slats, each slat having a top wall, a bottom wall and first and second opposed side walls, a groove formed in each of said first side walls of each of said slats, a side wall recessed portion formed in one of said first and second side walls of each of said slats below said groove, a bottom recess formed in each of said bottom walls of each of said slats adjacent a respective second side wall, a method comprising the steps of supplying a plurality of connectors, a vertical portion extending upwardly from said base and a generally horizontal portion, a method comprising the steps of securing a connector to a substrate, placing a slat on said substrate with said horizontal portion extending into said groove formed in said first side wall to thereby secure said slat in position, and continuing to place subsequent slats in a side by side abutting relationship with a connector holding each slat in position.
